(19) United States
(12) Patent Application Publication
(10) Pub. No.: US 2017/0193615 A1
(43) Pub. Date: Jul. 6, 2017

(54) Method, Apparatus and System for Choosing a Vacation

(71) Applicant: Luxtripper Limited, London (GB)

(72) Inventor: Nena Chaletzos, London (GB)

(21) Appl. No.: 15/460,405

(22) Filed: Mar. 16, 2017

Related U.S. Application Data
(63) Continuation-in-part of application No. 14/487,751, filed on Sep. 16, 2014, now abandoned.

(30) Foreign Application Priority Data
Feb. 11, 2015 (GB) PCTGB2015/000050

(51) Int. Cl. G06Q 50/14; G06F 17/30; G06Q 10/02

(52) U.S. Cl. CPC G06Q 50/14; G06Q 10/02; G06F 17/30702; G06F 17/30696; G06F 17/30719

(57) ABSTRACT

A computing system configured to create a data result set that relates to potential vacation destinations selected to satisfy user-entered customer data that the computing system employs to create a customer profile, the computing system comprising:
a plurality of servers, at least one of the servers configured to comprise a plurality of separate databases, at least one database configured to store summary-level data, at least one other database configured to store detail data;
the computing system configured to implement a method comprising the steps of:
i. receiving data entered into the computing system by a user, the data relating to two or more customer travel requirements;
ii. retrieving summary data from the summary-level database based on the data entered into the computing system interface by a user;
iii. retrieving detail data from the detail database based on the data entered into the computing system interface by a user;
iv. presenting at least a portion of the retrieved data to a user as a number of discrete vacation destinations.

This is a continuation-in-part of my copending application Ser. No. 14/487,751 filed Sep. 16, 2014, and also claims benefit of International Application PCT/GB/2015/000050, filed 11 Feb. 2015, now published as WO2016/042282.

### FIELD OF THE INVENTION

The present invention relates to a method, apparatus and system for choosing a vacation. More particularly, the present invention relates to a system and method for choosing a vacation that carries out searching and provides results quickly and accurately.

### BACKGROUND

Most people will schedule at least one vacation or holiday a year in order to take a break from their daily lives and recharge their batteries. This normally involves travelling to a holiday destination. Usually, when people decide to go on vacation or holiday, they will spend a significant amount of time deciding generally where to go (country and/or area of the world). Once they have decided on a destination, or have a shortlist of potential destinations, they will then carry out further research into each destination and determine from their research where in particular they will travel to, taking into account which month or what time of year they would like to travel (for example, the weather at a particular time of year will be an important deciding factor), and whether the destination option gives them the experience they require at that time of year and within their desired budget.

A customer or group of customers will also have to find and analyse hotel or accommodation reviews within the chosen destination area, and then go through these to ensure they also match their requirements. After a number are short-listed, the final deciding factor is, again, usually the price.

A customer may then spend additional time researching and booking activities that coincide with their time away, which adds further time and effort, and may cause them to re-think their destination and have to start the process again if they cannot find suitable activities or book these to coincide within the scheduled window of their visit.

Due to the nature of modern commerce and the easy availability of information, the final step of the process before booking will usually involve the customer spending additional time looking for offers which match the budget they have set and which include all their requirements (flights, accommodation, transfers etc).

At this final stage if the search results do not match all the necessary criteria, then the whole process will normally be started again.

Due to the large number of factors which need to be considered, the prevalence and easy availability of information and the number of steps in the process, the overall time taken to decide on and book a vacation can take weeks and even months. People will generally spend a significant amount of money on their vacation and it is a major event in their lives. As they are spending a lot of money they want to ensure they balance all of the many factors to make the right choice.

If they are using an on-line site such as for example Expedia for research, a customer will be presented with pages of results for their destination and multiple pages of associated offers. Users can feel overwhelmed and may feel that they have to check and review every offer to ensure they pick what is best or right for their requirements. This can add significantly to the time required to complete the overall process.

It is an object of the present invention to provide a method for choosing a vacation which goes some way to overcoming the abovementioned disadvantages or which at least provides the public or industry with a useful choice.

It is a further object of the present invention to provide a system for choosing a vacation which goes some way to overcoming the abovementioned disadvantages or which at least provides the public or industry with a useful choice.

It is a further object of the present invention to provide an apparatus for choosing a vacation which goes some way to overcoming the abovementioned disadvantages or which at least provides the public or industry with a useful choice.

It is a yet still further object of the present invention to provide a combined system or apparatus and method for choosing a vacation which goes some way to overcoming the abovementioned disadvantages or which at least provides the public or industry with a useful choice.

Further objects and advantages of the invention will be brought out in the following portions of the specification, wherein the detailed description is for the purpose of fully disclosing the preferred embodiment of the invention without placing limitations thereon.

The background discussion (including any potential prior art) is not to be taken as an admission of the common general knowledge.

### SUMMARY OF THE INVENTION

The term “comprising” as used in this specification and indicative independent claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

In an aspect, the invention may broadly be said to consist in a computer-implemented method of creating a data result set within a computing system that relates to potential vacation destinations, the method comprising the steps of:
i. receiving data entered into a computing system interface by a user, the data relating to two or more of; type of traveller, the required time of travel, and the weather requirements;
ii. entering data relating to the vacation experience desired;
iii. retrieving data from a data store based on the parameters defined by the user profile created by the entry of the data in steps i and ii;
iv. presenting at least a portion of the retrieved data to a user as a number of discrete vacation destinations.

In an embodiment, the retrieved data is presented to a user on their interface as a list.

In an embodiment, each entry in the list comprises a display of header detail, each entry in the list further configured so that further information for each entry is viewable by click-through.

In an embodiment, the computer-implemented method further comprises the step of filtering the retrieved data by price.

In an embodiment, the computer-implemented method further comprises the step of filtering the retrieved data by length of travel.

In an embodiment, the computer-implemented method further comprises the step of filtering the retrieved data by room type.

In an embodiment, the computer-implemented method further comprises the step of filtering the retrieved data by available upgrades.

In an embodiment, the available upgrades comprise one or more of: flight upgrades, room upgrades.

In an embodiment, the computer-implemented method further comprises the step of filtering the retrieved data by additional services.

In an embodiment, the additional services comprise one or more of: tours, transfers, airport lounges, activities, excursions.

In an embodiment, the computer-implemented method further comprises the step of filtering the retrieved data by pre-arranged tour.

In an embodiment, the results are sent to a user as an e-brochure.

### BRIEF DESCRIPTION OF THE DRAWINGS

Further aspects of the invention will become apparent from the following description which is given by way of example only and with reference to the accompanying drawings which show embodiments of the device by way of example, and in which:

FIG. 1 shows a schematic overview of the architecture of a system suitable for an embodiment of the present invention, with the main building blocks or system elements and the main connections between these elements shown.

FIG. 2 shows a schematic overview flow diagram of a method of choosing a vacation according to a first embodiment of the present invention.

FIG. 3 shows a schematic overview flow diagram of a method of choosing a vacation according to a second embodiment of the present invention.

FIG. 4 shows a schematic view of a first embodiment of the main display interface that a user will use to enter data in the first step of the method of FIG. 2.

FIG. 5a shows a schematic view of a second embodiment of the main display interface that a user will use to enter data in the first step of the method of FIG. 3.

FIG. 5b shows a schematic view of a second embodiment of the main display interface that a user will use to enter data in the second step of the method of FIG. 3.

FIG. 6 shows a typical view of an embodiment of the main display interface of FIG. 4 as it appears on screen to a user entering data carrying out the method of FIG. 2.

FIG. 7 shows a typical view of an embodiment of the main display interface of FIGS. 5a and 5b as they appear on screen to a user entering data carrying out the method of FIG. 3.

FIG. 8a shows a typical results page, generated when the steps of the method of FIG. 2 are completed, that shows a partial list of the results generated by completing the method, the list entries displaying relevant but minimal header details, a user or users able to click within each results box for further information on that particular recommended package, and to find out more about the package (e.g. hotel, flights, transfers, etc).

FIG. 8b shows a typical results page, generated when the steps of the method of FIG. 3 are completed, that shows a graphical representation of the globe with the potential destinations generated by completion of the initial steps highlighted, a partial list of the results generated by completing the method shown below the globe graphic, the list entries displaying relevant but minimal header details, a user or users able to click within each results box for further information on that particular recommended package, and further filter boxes shown that allow a user to add further filters to the shortlist to further narrow down the results.

FIG. 9 shows a more detailed view of the elements of the system of FIG. 1 and their inter-operation, a user shown interfacing with the system via their user interface, the processing module and data retrieval engine of the system of FIG. 1 further comprising a load balancer, servers configured to run ‘where to go when’ rule sets, and a processing server running a processing logic/rule set, the data store comprising a number of specialised databases, and back office users and external sources accessing the system to add to and update the system, the portion of the system running the ‘where to, go when’ process shown bounded within a box.

FIG. 10 shows a detail view of the ‘where to go when’ process that takes place within the boundaries of the box shown in FIG. 9, when the ‘where to go when’ logic/rule set is applied to the data in the specialised databases.

FIG. 11 shows an embodiment of the process by which the results are personalised for a user based on their current and previous search terms.

### DETAILED DESCRIPTION OF THE INVENTION

Embodiments and variations thereof of the present invention will now be described with reference to the figures.

### Overview

The present invention provides a method, system and apparatus for choosing a vacation where the number of steps required (and hence the time required) to complete the choosing process is minimised, and where the search process and the apparatus/system is configured in such a way that certain types of data are requested in a certain manner, in order to minimise the processing power required and to return the results within a minimised time period.

The system creates a profile of a user or customer from information which they enter, and then creates and presents a results list that suits the particular profile based on the profile information entered. The process rapidly returns a list of items to a user based on multiple data dimensions, and will interpret the search terms as entered based on a personalised understanding of the intent of the user when entering each search term. The way in which the system achieves this is described in detail below, and allows the system to return results more rapidly and using less processing capability than for similar and already-known systems.

Embodiments of the method, and the system that supports the method, will now be described.

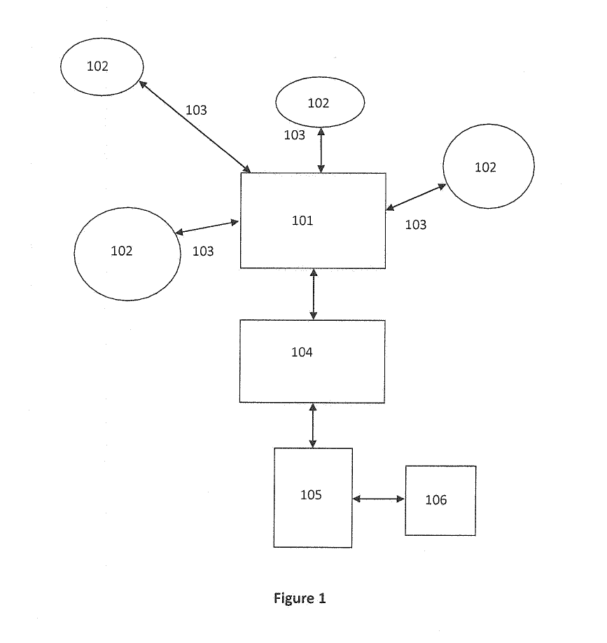

A schematic overview of the architecture of a system 1 suitable for the preferred embodiments, with the main building blocks or system elements and the main connections between these elements, is shown in FIG. 1. A data store 101 is shown. The data store 101 can be a server, an enterprise data warehouse, an operational data store, a data mart, a storage array, or similar, and can be of the type which receives and stores data from multiple sources 102, which may be widely geographically separated. Further, the data store may at least partly be a cache memory used to temporarily store incoming data captured in real time—for example streaming data. The data store 101 may also be a centralised location, or a distributed network. Data stored in the data store 101 relates to vacation or holiday information. For example, hotel availability and price, weather data relating to the prevailing weather for a time of year based on historical data, flight details, activity details linked to a geographic location (for example museums or galleries in a certain city, scuba diving or snorkelling excursions linked to location, etc), restaurant details linked to a location, car hire outlets, other equipment hire outlets (jet skis, sailing vessel charters, etc) and other relevant details. The data can be entered by an authorised user logging on to the system via a remote terminal that acts as the source 102. The data can be sent to the data store 101 from the terminals or sources 102 by way of any suitable communication system 103—for example, wireless transmission, transmission via an established telephone network (mobile or landline), via a built-in hardwired grid, etc. If the terminals 102 are geographically separated from the data store 101 by longer distances, then a combination of these elements may be used to transmit and receive the data. The internal architecture of the data store 101 will be described in further detail below.

A data retrieval engine 104 is in communication with the data store 101 to enable the stored data to be retrieved and transferred to other elements of the system. A processing module 105 is in communication with the data retrieval engine 104 to receive the data and process this as outlined below. The data retrieval engine 104 and processing module 105 are in communication with external inputs from an end user via a customer terminal or user interface 106.

Generally, the terminal or terminals 102 are in communication with, but do not form part of, the core portion of the system (which comprises but is not limited to: the data store 101, the data retrieval engine 104, the processing module 105, and any links/connections to, or which form part of, the communication system 103). The terminals 102 may be terminals used by direct employees or trusted associates to upload data to the data store—for example a travel agent or airline may upload new or revised flight data, an associated hotel chain operative or employee may upload data relating to a special offer, new menus, or new details of activities. The terminals 102 may also be employee terminals that are used to add, remove and amend data, and which can be used to alter the parameters by which the programming module 105 operates in order to change the results generated by the entry of certain parameters or to alter the parameters which can be entered (e.g. to change fields for users to enter data, to change the entries on user menus, etc).

Similarly, the user terminal 106 by which a user connects with the system does not have to form part of the core portion of the system, and is mostly likely to be their own personal terminal: for example a mobile device, a laptop, PDA/tablet device, or desktop PC. Alternatively the user terminal 106 could be a terminal located at a travel agent or similar, with the agent assisting a customer in making their choices and entering data as required.

Further details of an embodiment of the system 1 are provided below in the sub-section titled ‘system details’.

### Creating a Customer Profile

### First Embodiment

The method of choosing a vacation according to a first embodiment of the present invention, and the associated system and apparatus, will now be described.

The method is carried out by entering data into an interface that is designed to provide data relating to relevant points. In this example, the three data points entered are:
1: what month does the user/users wish to travel?
2: what are their weather requirements?
3: what experience do they desire from their holiday?

However, it should be noted that various and many other data items or data dimensions could be also be used, either in combination with or in place of those specifically mentioned, such as for example current geospatial location, a desired experience type, the type of traveller, etc.

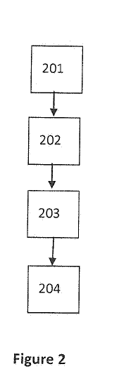

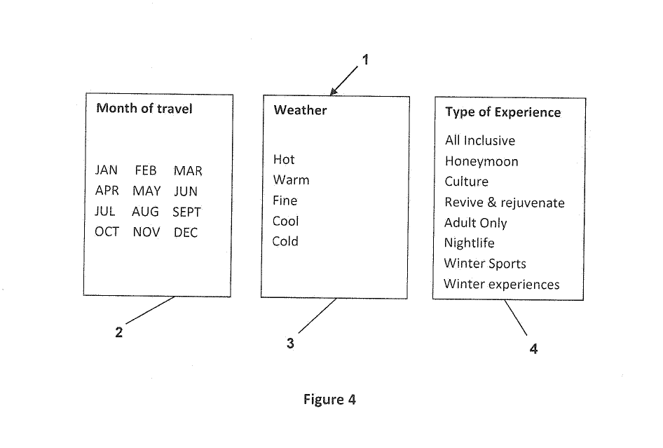

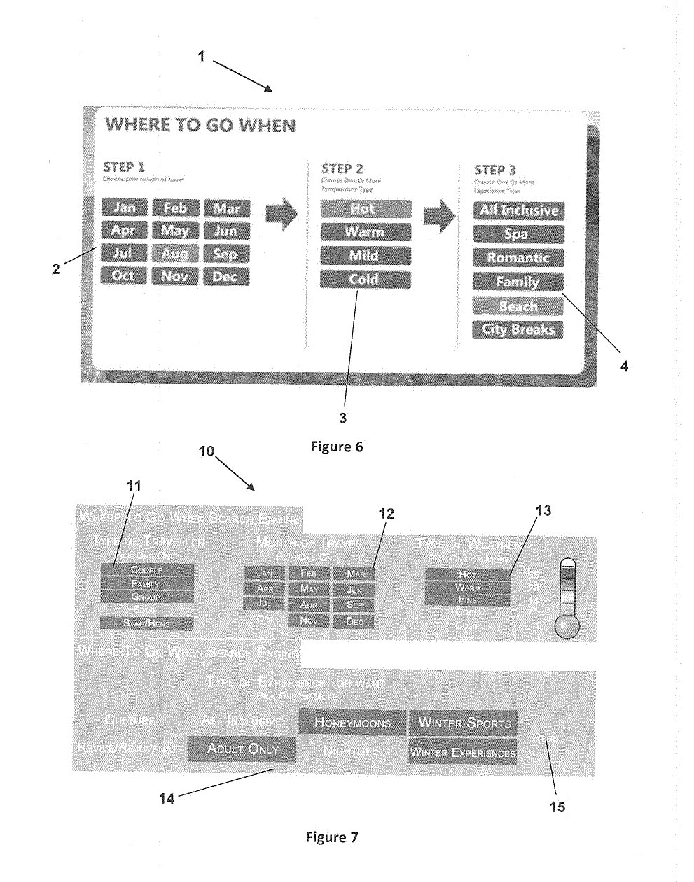

In this first example or first embodiment described and shown the data entry is achieved by presenting the user with a single screen or display on their interface 106, with three data entry steps or menus that they need to complete in order to be presented with a result set. The overall process is shown by the flow chart in FIG. 2. As shown in FIGS. 4 and 6, in order to complete the first step of the method (step 201 in FIG. 2), a user is presented with a point-and-click interface 1 where they are required to enter data in three profile boxes. Firstly, the user chooses when they wish to travel by clicking on the month list provided in the ‘month of travel’ box 2. Secondly, the user completes a ‘type of weather’ box 3, where a user chooses the type of weather they wish to enjoy by clicking on the list provided within box 3 (‘hot’, ‘warm’, ‘fine’ ‘cool’ and ‘cold’ are the choices provided in this embodiment). Thirdly, the user chooses what type of holiday experience they desire, choosing one from the menu list provided in the ‘type of experience’ box 4, by pointing and clicking on a choice within the list to choose the type of holiday they require in a similar manner to that outlined above for the first and second steps. In the embodiment shown, the choices provided are: ‘honeymoons’, ‘all inclusive’, ‘safari and trekking’, ‘cultural’, ‘revive and rejuvenate’, ‘nightlife’ and ‘adult only’. Once this step has been completed, a user profile is created.

It should be noted that data can be entered in the boxes in any order. That is, data entry is not limited to linear entry in the order of box 2, box 3, box 4—a user can enter the ‘type of experience’ they desire in box 4 before moving back to complete boxes 2 and 3 (in any order).

The user profile created is based on the entry of the data in step 201. The data which a user has entered is sent from their interface 106 to the processing module 105, which uses pre-programmed parameters to create an individual profile (step 202 in FIG. 2). The processing module is in communication with the database or data store 101 via the data retrieval module 104. The processing module 105 interrogates the data store 101, and instructs the data retrieval module 104 to retrieve data from the data store 101, with the selected retrieved data based on the parameters defined by the user profile created in step 202. The data retrieval module 104 retrieves and delivers the data to the processing module 105 at step 203, the processing module 105 then presenting/delivering these results to the interface 106 at step 204. The results delivered relate to the recommended destinations, recommended hotels, weather updates as per the search criteria and finally only locations fitting to the experiences as refined within the search.

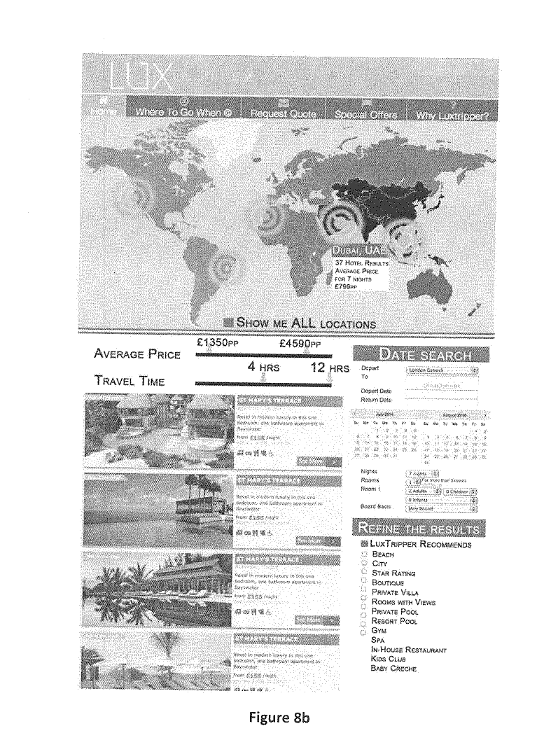

As shown in FIG. 8a, in this embodiment the results are delivered as discrete entries, for example boxes arranged in a list, with relevant but minimal header details displayed. A user or users can then click within each results box for further information on that particular recommended package, and to find out more about the package (e.g. hotel, flights, transfers, etc).

### Second Embodiment

The method of choosing a vacation according to a second example or embodiment of the present invention, and the associated system and apparatus, will now be described.

The method is similar to that described above for the first embodiment, and is carried out by entering data into an interface that is designed to provide data relating to the following points:
1: what type of traveller is the user
2: what month do they wish to travel
3: what are their weather requirements
4: what experience do they desire from their holiday.

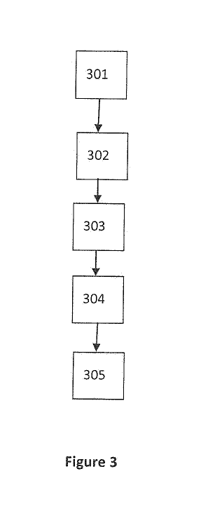

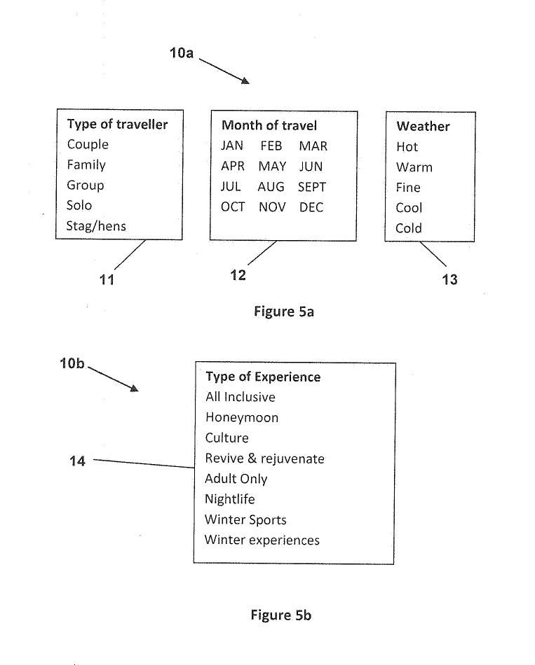

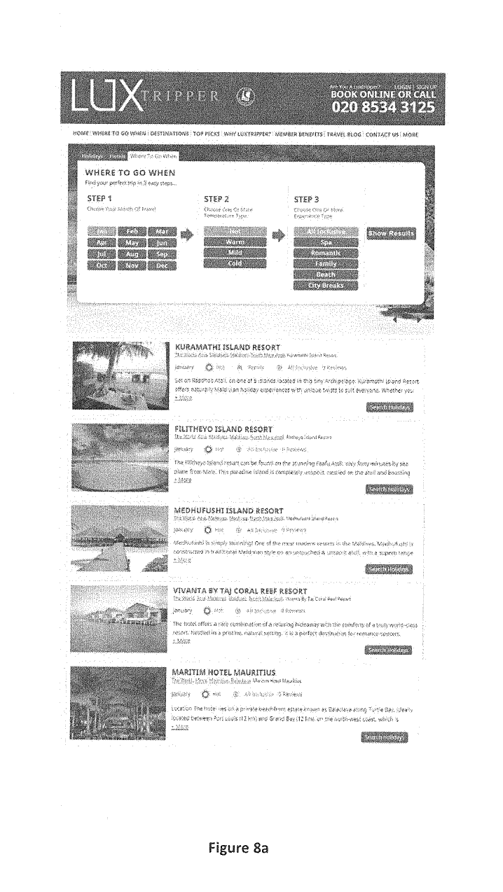

In the embodiment described and shown this is achieved by presenting the user with two data entry steps that they need to complete in order to be presented with a result set. The overall process is shown by the flow chart in FIG. 3. As shown in FIGS. 5a, 5b and 7, in order to complete the first step of the method (step 301 in FIG. 3), a user is presented with a point-and-click interface where they are required to enter data in three profile boxes. The interface in this embodiment is generally numbered as interface 10, with the first interface part 10a shown in FIG. 5a, and the second interface part 10b shown in FIG. 5b. The first part of first interface 10a is a ‘type of traveller’ box 11, where a user specifies what type of traveller they are from a list provided (in this embodiment, the choices provided are: ‘Couple’, ‘Family’, ‘Group’, ‘Solo’, ‘Stag/Hen’. It should be noted that ‘type’ in this context can relate to an individual traveller, or more than one traveller, such as a couple or group). A user then chooses the month in which they wish to travel by clicking on the month list provided within box 12; and finally the user completes a ‘type of weather’ box 13, where a user chooses the type of weather they wish to enjoy by clicking on the list provided within box 13 (‘hot’, ‘warm’, ‘fine’ ‘cool’ and ‘cold’ are the choices provided in this embodiment, as shown in FIG. 5a). Data can be entered in the boxes in any order. That is, data entry is not limited to linear entry in the order of box 11, box 12, box 13—a user can enter the weather they desire in box 13 before moving back to complete boxes 11 and 12 (in any order). It should also be noted that the user also does not have to complete every step in order to get the results—for example, a user or users can complete the ‘type of traveller’ box 11 (for example, to indicate that they are a couple), then skip or miss out the month list provided within box 12, then add their weather type and experience by completing the ‘type of weather’ box 13. Once a user has completed their choices in boxes 11, 12, and 13 in step 1, they move on to step 2.

As shown in FIG. 5b, at step 2 (step 302 in FIG. 3), a user is asked to choose what type of holiday they desire, by choosing one from the menu list provided in the ‘experience type’ box 14, by pointing and clicking on a choice within the list to choose the type of holiday they require in a similar manner to that outlined above for the first step. In the embodiment shown, the choices provided are: ‘honeymoons’, ‘all inclusive’, ‘safari and trekking’, ‘cultural’, ‘revive and rejuvenate’, ‘nightlife’ and ‘adult only’. Once this step has been completed, a user profile, is created.

It should be noted that in this embodiment, the user can move on to the next screen or create a results list, even if not all the boxes have been completed (for example, if only two of the boxes 11, 12, 13 have been completed), by clicking on the ‘results’ button 15 as shown in the bottom right of FIG. 7. In the embodiment shown in FIG. 7 and as described, the interface allows for the completion of steps 301 and 302 on the same screen, with boxes 11, 12, 13 on a top ‘row’, and box 14 forming a lower ‘row’ on the screen. A results list is still generated and provided to a user, based on the information that a user has provided.

The user profile created is based on the entry of the data in steps 301 and 302. The data which a user has entered is sent from their interface 106 to the processing module 105, which uses pre-programmed parameters to create an individual profile (step 303 in FIG. 2). The processing module is in communication with the database or data store 101 via the data retrieval module 104. The processing module 105 interrogates the data store 101, and instructs the data retrieval module 104 to retrieve data from the data store 101, with the selected retrieved data based on the parameters defined by the user profile created in step 303. The data retrieval module 104 retrieves and delivers the data to the processing module 105 at step 304, the processing module 105 then presenting/delivering these results to the interface 106 at step 305. The results delivered relate to the recommended destinations, recommended hotels, weather updates as per the search criteria and finally only locations fitting to the experiences as refined within the search.

The results are delivered as discrete entries, for example boxes arranged in a list, with relevant but minimal header details displayed. A user or users can then click onto each results box for further information on that particular recommended package, and to find out more about the package (e.g. hotel, flights, transfers, etc).

A user can take advantage of further filters that are available on the results page, that allow the user to further define their package. That is, to further filter the retrieved data. These can include filtering by price, length of travel, room types, and available upgrades. The user can also add on additional services such as tours and transfers/airport lounges based on their requirements. This could be achieved by clicking on a filter button (e.g. a ‘filter by price’ button), or by accessing a drop-down menu. For example, a price filter menu could have different price ranges pre-specified in the menu entries, or could have a box or boxes that a user completes to enter data that relates to one or both of their minimum/maximum price requirements. This further filtering is applied to the previously generated results set.

The results are provided globally (i.e. all destinations across the world that fit within the profile are included in the results delivered). However, by default the system will only provide the first twenty results. Limiting the results to twenty in the first instance allows the user to make informed decisions without an influx of options/packages and in a much shorter time frame.

A typical results page is shown in FIG. 8b, as generated when the steps of the method of FIG. 3 are completed. A graphical representation of the globe with the potential destinations generated by completion of the initial steps highlighted is shown at the top, with a partial list of the results generated by completing the method shown below the globe graphic, the list entries displaying relevant but minimal header details and a user or users able to click within each results box for further information on that particular recommended package. Further filter boxes are shown in the centre and to the side that allow a user to add further filters to the shortlist to further narrow down the results, these including a ‘price’ filter and a ‘travel time’ filter, and a filter to refine the results by additions such as ‘private pool’, ‘creche’, ‘gym’, spa’, etc.

If a user adds further filters, these can be used to filter the results already displayed (the default being 20, but the total number displayed user-specifiable), or the total can be kept at the previously specified number (e.g. the default of 20), with irrelevant results based on the new filters removed, and new results added to keep the numbers as specified.

In both the first and second embodiment described above, the information required, and the method used to achieve the outputted results, differs from what is currently known and used. Currently when users are searching for destination inspiration and affordable packages, they are asked to provide input data which includes: their destination, dates, how many travellers, etc. That is, before they start using a system or method such as are known in the art, they are already required to have an idea of where they wish to go.

The systems and methods of the present invention are structured so that a user is only required to enter a minimal amount of information in order to create a user profile so that a suitable result set can be provided. A customer or user is not required to know or have an idea of their preferred destination and exact dates before the profile is created. All that a user needs to know in order to choose a vacation is who they are as a traveller (what sort a traveller they are, or what sort of vacation they desire), when they wish to travel, and what type of weather/experience they would like. By asking for this data, and arranging the data input in the manner described, the time taken both for the system on which the method is performed to produce a satisfactory result and provide the user or customer with relevant options is greatly reduced. Also, the overall processing power required by the system is greatly reduced. From the point of view of a user, the time taken to decide on and book their vacation is considerably reduced. Once global destination results are produced, a user can refine the process and come up with a specific destination that suits them.

It has further been found that entering data relating to the vacation experience desired at the first entry screen, before creating the user profile, has the effect of significantly and surprisingly reducing the time taken both for the system on which the method is performed to produce a satisfactory result and provide the user or customer with relevant options, and also surprisingly significantly reduces the overall processing power required by the system.

Tailoring the search results in this manner helps to ensure that no extraneous or wasted information is given to the customer. They are not required to spend so much time data-mining.

### System Details

Further details of a system suitable for performing the method described above will now be described in more detail.

The processor of processing module 105 is arranged to perform the steps of a program stored as program instructions within the memory device. The program instructions enable the various methods of performing the invention as described herein to be performed. The program instructions, may be developed or implemented using any suitable software programming language and toolkit, such as, for example, a C-based language and compiler. Further, the program instructions may be stored in any suitable manner such that they can be transferred to the memory device or read by the processor, such as, for example, being stored on a computer readable medium. The computer readable medium may be any suitable medium for tangibly storing the program instructions, such as, for example, solid state memory, magnetic tape, a compact disc (CD-ROM or CD-R/W), memory card, flash memory, optical disc, magnetic disc or any other suitable computer readable medium.

The processing module 105 is also configured to be able to sort data and arrange this for visualisation, by utilising the data retrieval module 104 that is in communication with the data storage systems or devices that form the data store 101.

It will be understood that the system herein described includes one or more elements that are arranged to perform the various functions and methods as described herein. The embodiments herein described are aimed at providing the reader with examples of how various modules and/or engines that make up the elements of the system may be interconnected to enable the functions to be implemented. Further, the embodiments of the description explain, in system related detail, how the steps of the herein described method may be performed. The conceptual diagrams are provided to indicate to the reader how the various data elements are processed at different stages by the various different modules and/or engines.

It will be understood that the arrangement and construction of the modules or engines may be adapted accordingly depending on system and user requirements so that various functions may be performed by different modules or engines to those described herein, and that certain modules or engines may be combined into single modules or engines.

It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using, any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device.

The methods described herein may be implemented using a general purpose computing system specifically configured and programmed to perform the described steps. Alternatively, the methods described herein may be implemented using a specific computer system such, as a data sorting and visualisation computer, a database query computer, a graphical analysis computer, a gaming data analysis computer, a manufacturing data analysis computer, a business intelligence computer etc., where the computer has been specifically adapted to perform the described steps on specific data captured from an environment associated with a particular field.

### System Functionality

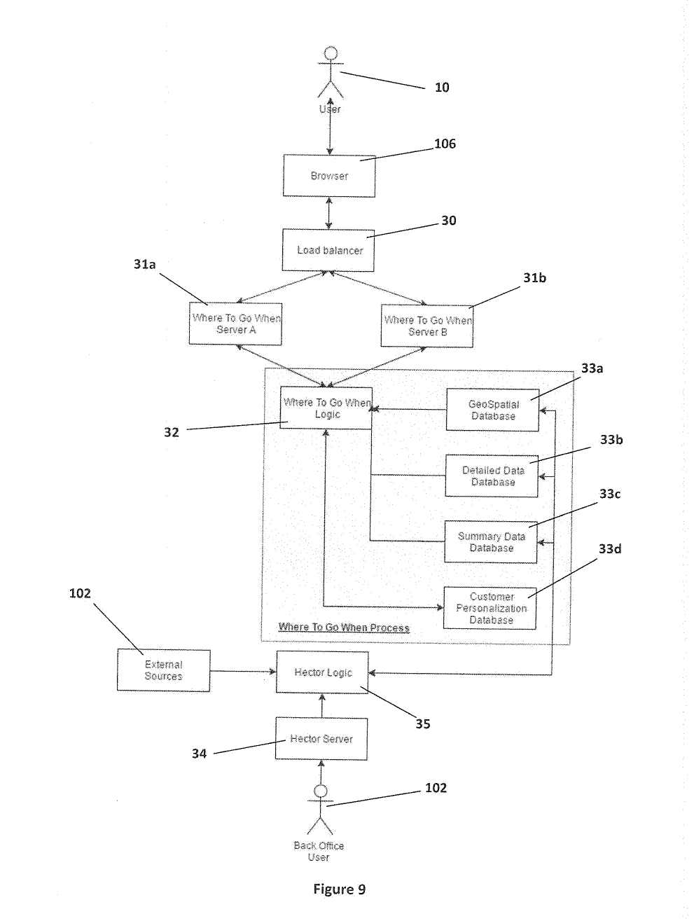

The manner in which the system is constructed and configured, and the manner in which it operates, will now be described, with reference to FIGS. 9, 10, and 11. The advantages of this arrangement will be described in detail with reference to FIGS. 9, 10 and 11.

A top-level outline of the process is shown in FIG. 9. A user 10 interfaces with the system via their user interface 106, which as described above can be their own personal terminal such as for example a mobile device, a laptop, PDA/tablet device, or desktop PC, and which receives data from the user and transmits this onwards, and which presents data from the system to a user.

The elements shown in the chart of FIG. 9 comprise: a load balancer 30; servers 31a, 31b; a logic or rule set 32 (‘where to go when’ rule set 32) running across servers 31a, 31b, a number of specialised databases 33a, 33b, 33c, 33d; and; a processing server 34 running a logic/rule set 35. In a similar manner to that described above and as shown in FIG. 1, back office users 102 are able to add to and update the system via links 103.

The elements shown in FIG. 9 correspond generally to the retrieval module 104 and processing module 105 of the embodiments described above—that is, these elements form the retrieval module 104 and processing module 105, and FIG. 9 shows the retrieval module 104 and processing module 105 in more detail.

The load balancer or balancers 30 act to split traffic across the servers 31a, 31b. The user 10 enters data via the interface 106. As described above, this process aims to capture a traveller profile via multiple data entry points or multiple questions: traveller type, month of planned travel, weather required/desired, experience type required/desired, budget, and preferred destinations. Once, or as, the data is captured, this is passed to the customer personalisation database 33d via the ‘where to go when’ logic/rule set 32 running across the servers 31a, 31b, and a customer profile is created. The customer personalisation database 33d stores customer personalisation data and creates a traveller profile or traveller DNA. Each time a new interaction with a user takes place via the interface 106, the data set is updated. Multiple rules sets (rule set 32) are applied, to predict the traveller buying intent. The data updates with each interaction and as further searches are conducted. The customer personalisation database 33d can also register the current location of a user (e.g. from their IP address), and order or prioritise results accordingly. That is, if a certain type of experience or weather is requested, with no particular information provided as to required location, the rule sets will provide or order the results in terms of proximity and/or travel pricing, to the user's current or ‘home’ location.

The customer profile is continuously updated as fresh data is added, and the profile is in constant communication with the logic/rule set 32, which is in communication with the specialised database, which in this embodiment is formed from databases 33a (geospatial database), 33b (detailed data database), and 33c (summary data database).

The summary database 33c is configured to store high-level information about data. The detailed data database 33b stores the full content. For example, for a single hotel as a datum, the summary database 33c can just store the hotel name, an identifier, an identifier for use within the detailed database, and any filterable data dimensions that might be associated with the hotel. In contrast, the detailed database 33b stores the entire data set associated with the hotel. The geospatial database 33a holds longitude and latitude and location based content. This data can for example relate to destinations: e.g. New York, Mauritius, Australia, The Maldives, etc. The database 33a receives the continuously-updated traveller profile, and filters this through the content, with filtered criteria sent on to the processing server 34/rule set 35.

The purpose of this configuration is to allow quick data filtering against the summary database 33c, and once this process is complete, to load the full content of the relevant located result set from the detailed database 33b, as the two databases are optimised for different purposes: the summary database 33c (configured as an SQL Server) is optimised for quick filtering, and the detailed database 33b (Document Database) is optimised for fast full-content retrieval.

For each of the specialised databases 33a, 33b, 33c, the process is as follows: the profile data is processed concurrently through these databases. Splitting the search through these databases speeds up the processing time. Once processed, the filtered data is sent back to the servers 31a, 31b and rule set 32, and onwards to the processing server 34 running rule set 35.

As outlined above, the detailed database 33b holds in-depth content for each entity (detailed hotel, location, weather, images, content data). The detailed database 33b also holds data relating to experiences—e.g. hiking, skiing, scuba diving, etc. The detailed database 33b receives the continuously-updated traveller profile, and filters this through the content, with filtered criteria sent on to the processing server 34/rule set 35.

The summary database 33c holds summary content data for each entity (summary hotel, location, weather, images, content data). The summary database 33c receives the continuously-updated traveller profile, and filters this through the content, with filtered criteria sent on to the processing server 34/rule set 35.

Each of the databases 33a, 33b, 33c can be DocumentDB or SQL server type databases. However, as outlined above it is preferred that the summary database 33c is configured as an SQL Server, and is optimised for quick filtering, and that the detailed database 33b is configured as a Document Database, optimised for fast full-content retrieval.

The system is able to deliver results within a minimised timeframe, and using reduced processing power, as the search is split through the databases, and this speeds up the processing time as follows: once the initial search terms have been entered, the summary database 33c is interrogated for an initial results set. This results set is then used for an in-depth interrogation of the detailed database 33b. As the data set required for in-depth interrogation is a subset of the total database, the processing power and time required to deliver the results is substantially decreased. This allows the databases to be optimised for storage of their own particular data points/datasets, as outlined above (e.g. as DocumentDB or SQL). The geospatial database 33a can be used to further minimise the result set required for detailed searching, if the user profile data indicates a preference for a particular location, for example.

The logic/rule set 35 running on processing server 34 receives the data from the databases 33a, 33b, 33c for processing. Data can also be received from the external sources 102, and any other relevant data stored on the server 34 (for example, this could have data storage relating to multiple data fields such as for example hotels, destinations, weather, pricing, descriptions, location info etc).

The data is processed, and multiple rules sets and logic are applied. Recommendations of content are returned to the databases 33a, 33b, 33c.

The system is further configured to learn from errors and improve results. For example, if a user carries out a particular search using particular terms, this shows an interest in these certain terms, which can then be weighted or prioritised accordingly. Once a user has been presented with results, if they click-through on any of the results presented (and leave others), this shows an interest in certain results or certain terms, and weighting or priority can be added accordingly. A subsequent enquiry shows further interest, and a booking shows very high interest.

In the systems as described above, any given data item (e.g. a Hotel, a Blog article, an Itinerary) can be associated with one or more filterable data dimensions. For example, a particular hotel can be associated with a data dimension such as a geospatial location, an experience or experiences, a traveller type etc. The data dimensions are stored in the specialised databases (33a, 33b, 33c, 33d, 34) grouped as dimension types. The effect of this association, and grouping is that the required computational power for each user query is lower than it would otherwise be. The data dimensions are separate from and separately editable to the actual content they filter. This allows the content itself to be stored in storage mediums that are suited for fast content retrieval (e.g. DocumentDB, SQL) but which are ill-suited for fast data filtering, but for results to still be produced rapidly and with minimisation of the computing power necessary to produce the results. The loose data dimensions allow the improved/minimised search times, and lower use of processing power, as described above.

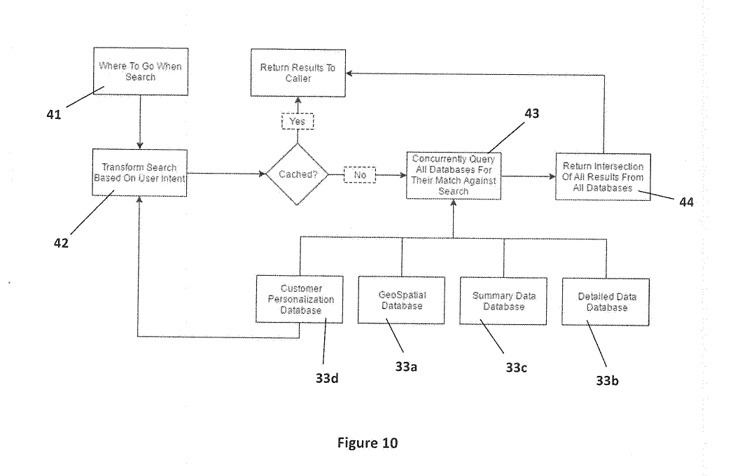

To provide users with the best possible matches in relation to a query, the system and method/process also needs to transform a user's exact queries (e.g. ‘Overwater villa in Mauritius’) to a series of dimensions that reflect the true intent of the user's search (e.g. ‘Overwater villa in Mauritius with swimming and hot weather’). An example of this process is shown in FIG. 10.

A user enters their data points in the manner described above, and as shown at box 41 in FIG. 10. The user's query is transformed into personalised dimensions based on their intent (as outlined in detail below) at box 42, and the databases 33a, 33b, and 33c are concurrently queried for each of their matches against the user's dimensions at box 43. The intersection(s) of all the queries are used to query the actual content that is returned to the user at box 44.

As an example, the user query ‘overwater villa’+‘Mauritius’+‘swimming’+‘hot weather’ might result in a set of matching locations (within Mauritius) from within the geospatial context (from database 33a), and a set of matching experience-dimensioned items from the summary database 33c (e.g. items with Overwater villas, swimming and hot weather). The intersection of these sets (i.e. the set of items which is contained in both) is ordered by their match to the user's personalised preferences, and this is then used to query the actual detailed content from the content database 33d, to return a personalised result set to the user.

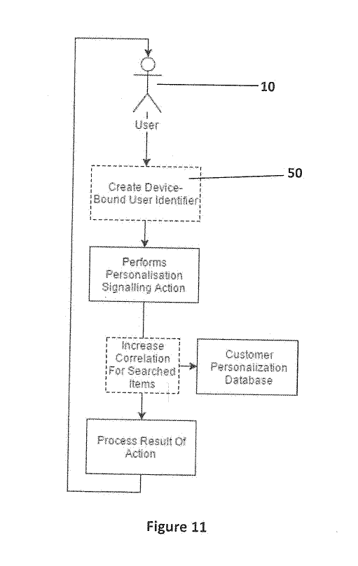

The personalisation process will now be described in detail with reference to FIG. 11.

To infer the user's preference for a certain dimension (e.g. hot weather) the user's interaction with, or absence of interaction with, elements of the site is tracked. From this interaction a level of signal (i.e. how strongly they like something) can be inferred or deduced. This is based on any actions they perform. Examples of actions can include:
Pausing when scrolling past an element or hovering the mouse over it. This can show a low signal of interest in the dimensions associated with that item.
Specifically querying for particular dimensions shows a strong signal of interest in those dimensions.
Visiting the page of an item (Hotel, Blog, Itinerary etc) for example by ‘clicking through’ shows a strong signal of interest in the dimensions associated with that item.
Paying money for an item (e.g. booking a Hotel) shows an extremely strong signal of interest in the dimensions associated with that item.

As shown in FIG. 11, when a user visits the site for the first time, a device-specific identifier is associated with their device that identifies them on all return visits (as shown at action box 50). This allows their personalisation profile to be improved over multiple visits without requiring them to log in at each visit. However, if a user does log in then all specific personalisation associated with their device is merged with their account personalisation as remotely stored.

When a ‘where to go when’ search is performed (as described above with particular reference to FIG. 10), the user's signalled interests are used to order the results in the order of those which most closely match their personalisation profile, by ordering items by the closeness of their associated data dimensions to the user's preferred data dimensions.

To infer the user's intent behind a certain dimension in the ‘where to go when’ search (e.g. to infer that by ‘Africa’ they mean to include ‘Mauritius’ as well, or that by ‘Hiking’ they mean ‘Hiking and Swimming’) the ‘where to go when’ dimensions are captured at the start of each complete ‘where to go when’ process. As the user signals their interests for any particular search, the signalled interests are associated with data dimensions from previous searches. When the correlations between multiple data dimensions are strong enough that patterns can be noted, the associated dimensions are automatically included in the ‘where to go when’ search whenever either dimension is entered by the user.

### Variations

In variants of the method and system outlined above, the menu choices provided in each of the first and second steps can differ. For example, the menu list ‘type of experience’ in box 4 in step 201 can include as additions or alternatives the menu choices: ‘romantic’, ‘family’, ‘beach’, and ‘city breaks’. Similarly, box 14 in step 302.

The system is customisable, either by a user or by an employee operator. For example, all of the menu options listed in the main embodiment and the variant additions and alternative can be included in any combination, a user adding or removing these from a personal repeat use profile. These could also be added or removed by an authorised employee to provide different menus for different users. For example, subscription members might have access or the option to include certain menu items such as ‘luxury packages’, or similar. A user can also choose to display greater or fewer than the 20 results provided by default.

In both of the embodiments, a user can either use the system themselves by logging on via their own terminal 106, or this can be done by for example a telesales team member, who can enter data into the system via questions and answers with a customer to carry out the same search and arrive at the same results.

A number of filters and menu items have been outlined above. For both embodiments, further menu items and/or filters can be added or included as required. These could include: tours, transfers, airport lounges, flight upgrades, activities, and excursions.

Another filter/menu item that can be added is data associated with a blog entry or similar. Secondary content describing a place and/or experience is created, and the data can be chosen as a filter for a user. That is, on reading the entry, if a user wishes to recreate the experience described for themselves, or wishes to visit the location, they can add this information as a filter.

The results can be provided as outlined above—as a results page with packages. As an alternative, a bespoke e-brochure of results could also be provided.

The results could also be filtered based on hotel only (e.g. to limit the results to one hotel chain or five-star hotels only.

The results can be based on pre-programmed tours by tourist companies/cruise ships.

The options list in the ‘type of traveller’ box 11 can be altered. For example, additional types of traveller could be added, or included in place of those listed above. For example: greys, gay, 1^{st} time travel couple, green (earth friendly), über-luxury travel, spiritualist, etc.

Similarly, the options list in the ‘experience type’ boxes 4 or 14 can be altered. For example, additional experiences such as: off the beaten track, experiential, wellness retreat, spiritual, escapism, religious, naturist, etc can be added.

As outlined above, the method utilises information input by a user to provide a results list that is indicative of a suitable destination at a suitable time—where a user should go and when.

In variations, the questions asked could be altered or tailored to provide a conceptually slightly different result.

For example, the questions could be tailored to provide results based on activities, excursions and traveller experiences—results indicative of what activities a user/users can do, and when.

It should be noted that as many filters as required can be added. Essentially, a filter corresponds to a closed curve of a Venn diagram, and the filters create the overlapping results set of a Venn diagram.

That is, in a computing system, a computer-implemented method of creating a data result set that relates to potential vacation destinations, the method comprising the steps of:
i. receiving data entered into the computing system via a user interface, the data relating to: the required activities, excursions, and the type of experience desired;
ii. retrieving data from a data store based on the parameters defined by the user profile created by the entry of the data in step i;
iii. presenting at least a portion of the retrieved data to a user as a number of discrete vacation activities.

The questions could also be tailored to provide results biased towards ways to travel, based on type of traveller, time of travel and experience and weather—results indicative of how to go, and when.

That is, in a computing system, a computer-implemented method of creating a data result set that relates to potential vacation destinations, the method comprising the steps of:
i. receiving data entered into the computing system via a user interface, the data relating to: the type of traveller, the weather requirements, and the type of experience desired;
ii. retrieving data from a data store based on the parameters defined by the user profile created by the entry of the data in step i;
iii. presenting at least a portion of the retrieved data to a user as a number of discrete ways to travel.

The questions could also be tailored to provide results based on a particular reason to travel—results indicative of why to go, and when. In order to provide the results, the profile will need to include information that indicates what type of traveller the user is, and the reason for their travel. This can be achieved by modifying the information input in step 201 or steps 301 and 302 for example, or as a further filter.

That is, in a computing system, a computer-implemented method of creating a data result set that relates to potential vacation destinations, the method comprising the steps of:
i. receiving data entered into the computing system via a user interface, the data relating to: the type of traveller, and the reason for travelling;
ii. retrieving data from a data store based on the parameters defined by the user profile created by the entry of the data in step i;
iii. presenting at least a portion of the retrieved data to a user as a number of discrete vacation destinations.

The method could also comprise the additional step of having a user enter one or both of the type of weather they desire, and the type of experience desired.

The questions could also be tailored to provide results based on who is most suitable to travel with—results indicative of who to go with, and when to go with them. The data entered would be suitable for creating a networking travel profile that is then matched with similar user profiles, and/or which is matched with profiles that indicate the type of person you would like to travel with.

That is, in a computing system, a computer-implemented method of creating a data result set that relates to potential vacation destinations, the method comprising the steps of:
i. receiving data entered into the computing system via a user interface, the data suitable for creating a networking travel profile;
ii. retrieving data from a data store based on the parameters defined by the user networking travel profile created by the entry of the data in step i;
iii. presenting at least a portion of the retrieved data to a user as a number of vacation partners.

The questions could also be tailored to provide results biased towards a suitable time to travel to a particular location—when to go where.

The questions could also be tailored to provide results biased towards a suitable time to travel to a particular location—when to go where.

That is, in a computing system, a computer-implemented method of creating a data result set that relates to potential vacation destinations, the method comprising the steps of:
i. receiving data entered into the computing system via a user interface, the data relating to: the required general or specific destination or destinations, and the weather requirements;
ii. retrieving data from a data store based on the parameters defined by the user profile created by the entry of the data in step i;
iii. presenting at least a portion of the retrieved data to a user as a number of discrete vacation packages.

1. A computing system configured to create a data result set that relates to potential vacation destinations selected to satisfy user-entered customer data that the computing system employs to create a customer profile, the computing system comprising:
a plurality of servers, at least one of the servers configured to comprise a plurality of separate databases, at least one database configured to store summary-level data, at least one other database configured to store detail data;
the computing system configured to implement a method comprising the steps of:
i. receiving data entered into the computing system by a user, the data relating to two or more customer travel requirements;
ii. retrieving summary data from the summary-level database based on the data entered into the computing system interface by a user;
iii. retrieving detail data from the detail database based on the data entered into the computing system interface by a user;
iv. presenting at least a portion of the retrieved data to a user as a number of discrete vacation destinations.

2. A computing system as claimed in claim 1 wherein steps i. and ii. of the method take place substantially concurrently.

3. A computing system as claimed in claim 1 or claim 2 wherein in the step of retrieving detail data from the detail database, the data set searched comprises the data retrieved in step ii.

4. A computing system as claimed in claim 1 further comprising a load balancer configured to distribute user requirement data entered into the system.

5. A computing system as claimed in claim 1 wherein the detail data comprises one or more filterable data dimensions.

6. A computing system as claimed in claim 5 wherein the filterable data dimensions may comprise one or more of: traveller type; month of planned travel; weather required/desired; experience type required/desired; budget; preferred destinations; length of travel; room type; available upgrades; tours; transfers; airport lounges; activities; excursions.

7. A computing system as claimed in claim 5 wherein the filterable data dimensions can be edited independently of the associated data.

8. A computing system as claimed in claim 1 wherein the summary data comprises one or more of: name; identifier; detail database identifier.

9. A computing system as claimed in claim 1 wherein the detail data comprises all known data points relating to a database entry.

10. A computing system as claimed in claim 1 wherein the summary-level database is configured as an SQL server.

11. A computing system as claimed in claim 1 wherein the detail database is configured as a Document DB database.

12. A computing system as claimed in claim 1 further configured to create a customer profile from the data entered into the computing system by a user.

13. A computing system as claimed in claim 12 wherein the profile is created and updated based on the interaction of a user with presented data.

14. A computing system as claimed in claim 13 wherein the system is further configured to provide greater weighting to data terms the same as or similar to those chosen by a user to conduct their search when conducting further searches.

15. A computing system as claimed in claim 13 wherein the system is further configured to provide greater weighting to data terms the same as or similar to those in results data on which a user hovers or pauses, when conducting further searches.

16. A computing system as claimed in claim 13 wherein the system is further configured to provide greater weighting to data terms the same as or similar to those in results data where a user clicks through, when conducting further searches.

17. A computing system as claimed in claim 13 wherein the system is further configured to provide greater weighting to data terms the same as or similar to those in results data where a user booking is completed, when conducting further searches.

18. A computing system as claimed in claim 13 wherein the system is configured to provide progressively greater weighting to data terms the same as or similar to those in subsequent searches where a user: uses the same terms; hovers or pauses on a result or results; clicks through, or completes a booking.
